(19) United States
(12) Patent Application Publication
(10) Pub. No.: US 2026/0280195 A1
(43) Pub. Date: Sep. 17, 2026

(54) SHIELDED CONNECTOR, SHIELDED CONNECTOR ASSEMBLY AND TERMINAL CRIMPING METHOD

(71) Applicant: SUMITOMO WIRING SYSTEMS, LTD., Mie (JP)

(72) Inventors: Takahiro HASEGAWA, Mie (JP); Masato KAMEMURA, Mie (JP)

(21) Appl. No.: 19/561,967

(22) Filed: Mar. 10, 2026

(30) Foreign Application Priority Data
Mar. 13, 2025 (JP) 2025-040304

(51) Int. Cl. H01R 13/6592; H01R 43/04

(52) U.S. Cl. CPC H01R 13/6592; H01R 43/04

(57) ABSTRACT

A tubular metal shell, which is connected to a shield material of a mating connector when an electrical terminal is electrically connected to the mating connector, is attached to a shielded electric wire that shields against noise. The metal shell includes a crimping portion that is secured to the shielded electric wire by crimping, and a connection portion that contacts the shield material of the mating connector. A recess for suppressing deformation during crimping is formed in the metal shell before crimping over an entire area in a circumferential direction between the crimping portion and the connection portion.

### CROSS-REFERENCE TO RELATED APPLICATIONS

This application is based on and claims priority from Japanese Patent Application No. 2025-040304, filed on Mar. 13, 2025, with the Japan Patent Office, the disclosure of which is incorporated herein in its entirety by reference.

### TECHNICAL FIELD

The present disclosure relates to a shielded connector, a shielded connector assembly and a terminal crimping method.

### BACKGROUND

Conventionally, as disclosed in Japanese Patent Laid-Open No. H08-250218, a shielded electric wire in which a cylindrical metal shell is electrically connected to a braid of an electric wire has been known. The braid is exposed from a sheath that covers an insulated core wire and an exposed portion is folded back. The metal shell is secured to the braid by being clamped and crimped onto a folded portion of the braid.

When the shielded electric wire is attached to a connector and engages with a mating connector, a distal end of the metal shell at a side opposite a portion crimped onto the braid is electrically connected to a shield material of the mating connector. When the metal shell is clamped and secured to the braid, the distal end of the metal shell may deform into a flared shape due to spreading radially outward, upon stress from the clamping being transmitted to a contact side of the metal shell. In this case, there is concern that a shielded connection state is adversely affected, since a diameter of the tip of the metal shell does not assume the intended shape.

An object of the present disclosure is to provide a shielded connector and a shielded connector assembly whose metal shell can be stably connected to a mating connector, and a terminal crimping method.

This object is solved according to the invention by the features of the independent claims. Particular embodiments of the invention are subject of the dependent claims.

### SUMMARY

According to one aspect, there is provided a shielded connector for a shielded electric wire that is to be electrically connected to a mating connector, the shielded connector comprising: an electrical terminal to be connected to the mating connector; and a tubular metal shell that is to be connected to a shield material of the mating connector when the electrical terminal is electrically connected to the mating connector, wherein the metal shell includes at least one crimping portion that is secured to the shielded electric wire by crimping, and a connection portion that contacts the shield material of the mating connector, and at least one recess for suppressing deformation during crimping is formed in the metal shell before crimping in a circumferential direction between the crimping portion and the connection portion.

According to a particular embodiment, the at least one recess for suppressing deformation during crimping is formed in the metal shell before crimping over a substantially entire area in a circumferential direction between the crimping portion and the connection portion.

According to another aspect, there is provided a shielded connector assembly that includes: a shielded electric wire that is electrically connected to a mating connector via an electrical terminal; and a tubular metal shell that is connected to a shield material of the mating connector when the electrical terminal is electrically connected to the mating connector, wherein the metal shell includes at least one crimping portion that is secured to the shielded electric wire by crimping, and a connection portion that contacts the shield material of the mating connector, and at least one recess for suppressing deformation during crimping is formed in the metal shell before crimping (particularly over an entire area) in a circumferential direction between the crimping portion and the connection portion.

According to the above, the at least one recess particularly allows a crimping load applied to the crimping portion to be less likely transmitted to the connection portion, when the crimping portion of the metal shell is crimped or bent or deformed onto a shielding layer (particularly a braided wire) of the shielded electric wire.

Therefore, the connection portion of the metal shell particularly is less likely to undergo shape deformation during crimping of the metal shell. That is, shape deformation of the connection portion, which is connected to the shield material of the mating connector, at the metal shell is suppressed.

Thus, it is possible to successfully connect the metal shell to the mating connector.

According to a particular embodiment, when a dimension in an axial direction of the metal shell at the recess is defined as a groove width, the groove width of the recess is set to a value within a range from a value being approximately a thickness of the metal shell to about three times the thickness of the metal shell.

Particularly, when a dimension in a radial direction of the metal shell is defined as a groove depth, the groove depth of the recess substantially is set to a value greater than a thickness of the metal shell and/or smaller than about five times the thickness of the metal shell.

According to the above, the dimension of the groove width of the recess being optimal particularly further contributes to deformation suppression of the connection portion of the metal shell during crimping.

Further particularly, the recess is arranged at a position, in an axial direction of the metal shell, closer to a proximal end of the metal shell than a center in the axial direction.

According to the above, in the case of a structure in which the proximal end of the metal shell is crimped onto the shield material, the connection portion may deform into a flared shape upon the crimping load produced on the crimping portion being transmitted to the connection portion at a side opposite the proximal end. However, in the case of the present configuration, the deformation load on the crimping portion particularly is less likely to be transmitted to the connection portion and the metal shell is less likely to deform into a flared shape even when using a structure in which the proximal end of the metal shell is crimped, because the recess for deformation suppression during crimping is provided in the metal shell.

Further particularly, the crimping portion after crimping includes at least one close-fitting bent portion formed by bending a base material of the metal shell outward when forming the crimping portion at the metal shell.

According to the above, it particularly is possible to form a portion at the metal shell in which the base material is deformed as the close-fitting bent portion as intended, when securing the metal shell to the shield material by crimping.

According to another aspect, there is provided a shield connector assembly comprising a shielded connector according to the above aspect or a particular embodiment thereof crimped to a shielded electric wire.

According to another aspect, there is provided a terminal crimping method for manufacturing a shielded connector assembly including a shielded electric wire that is to be electrically connected to a mating connector via an electrical terminal and a substantially tubular metal shell that is connected to a shield material of the mating connector when the electrical terminal is electrically connected to the mating connector, the terminal crimping method comprising:
providing the metal shell including a crimping portion that is to be secured to the shielded electric wire by crimping and a connection portion that is to contact the shield material of the mating connector,
forming in the metal shell before crimping at least one recess for suppressing deformation during crimping in a circumferential direction between the crimping portion and the connection portion, and
securing the metal shell to the shielded electric wire by clamping a proximal end located farther than the recess in the metal shell using a crimping die and crimping the proximal end onto the shielded electric wire.

According to a particular embodiment, the at least one recess for suppressing deformation during crimping is formed over a substantially entire area in a circumferential direction.

Specifically, there is provided a terminal crimping method of the present disclosure is a method for manufacturing a shielded connector including a shielded electric wire that is electrically connected to a mating connector via an electrical terminal and a tubular metal shell that is connected to a shield material of the mating connector when the electrical terminal is electrically connected to the mating connector, the terminal crimping method including: in the metal shell before crimping including a crimping portion that is secured to the shielded electric wire by crimping and a connection portion that contacts the shield material of the mating connector, forming a recess for suppressing deformation during crimping over an entire area in a circumferential direction between the crimping portion and the connection portion, and securing the metal shell to the shielded electric wire by clamping a proximal end located farther than the recess in the metal shell using a crimping die and crimping the proximal end onto the shielded electric wire.

According to this configuration, the same effects can be obtained as those of the preceding aspects.

According to a particular embodiment, when a dimension in an axial direction of the metal shell at the recess is defined as a groove width, in the forming step the groove width of the recess is set to a value within a range from a value being approximately a thickness of the metal shell to about three times the thickness of the metal shell.

According to a particular embodiment, when a dimension in a radial direction of the metal shell is defined as a groove depth, in the forming step the groove depth of the recess substantially is set to a value greater than a thickness of the metal shell and/or smaller than about five times the thickness of the metal shell.

The present disclosure enables a metal shell of a shielded connector to be stably connected to a mating connector.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a shielded connector according to an embodiment.

FIG. 2 is an exploded perspective view of the shielded connector.

FIG. 3 is an exploded perspective view of a terminal assembly.

FIG. 4 is a side view of a metal shell before crimping.

FIG. 5 is a cross-sectional view of a securing portion of the terminal assembly and the metal shell in the shielded connector.

FIG. 6 is a cross-sectional view along VI-VI shown in FIG. 1.

FIG. 7 is a perspective view of the terminal assembly.

FIG. 8 is a perspective view showing an outline of a crimping die.

FIGS. 9A to 9C are explanatory diagrams showing a flow of a crimping process of the metal shell.

FIG. 10 is a stress distribution analysis diagram of a crimping load occurring in the metal shell when sandwiched by the crimping die.

FIG. 11 is a stress distribution analysis diagram of a crimping load occurring in the metal shell when separated from the crimping die.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

Hereinafter, specific examples of the present disclosure will be described with reference to the drawings. Note that the present disclosure is not limited to these examples, and is intended to include all modifications that are indicated by the claims and are within the meaning and scope of equivalents of the claims. The drawings may partially exaggerate or simplify configurations for convenience of description. Dimensional ratios of each portion may differ in reality.

### Shielded Connector 1

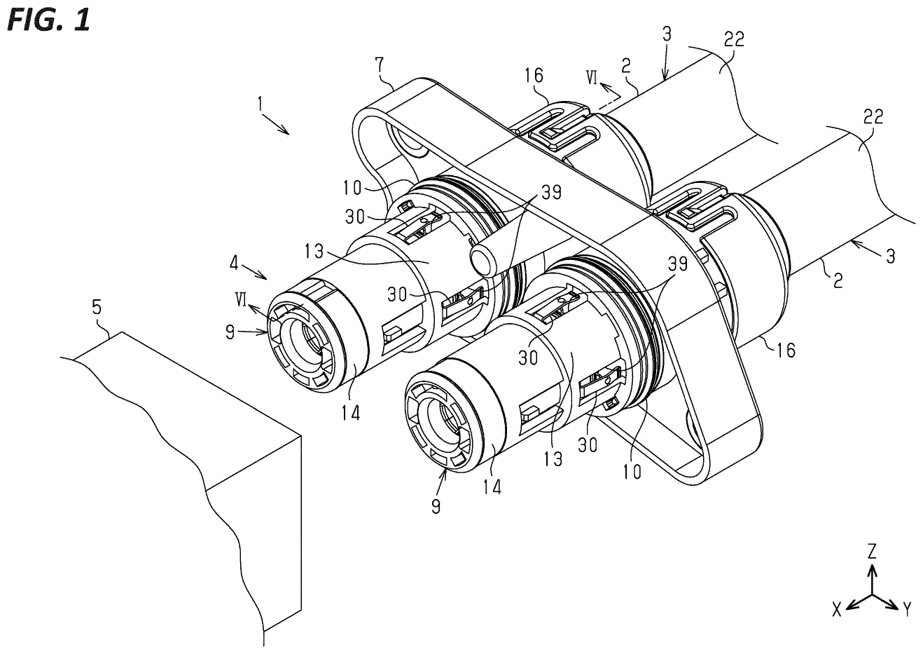

As shown in FIG. 1, a shielded connector 1 includes a terminal assembly 3 to be connected to a shielded electric wire 2, and a connector section 4 for connecting the terminal assembly 3 to a mating destination.

Specifically, one or more, particularly a pair of the terminal assemblies 3 are provided, one of which is usable as a positive line and the other is usable as a negative line.

Each terminal assembly 3 of the shielded connector 1 is electrically connected or connectable to a mating connector 5 via the connector section 4.

### Connector Section 4

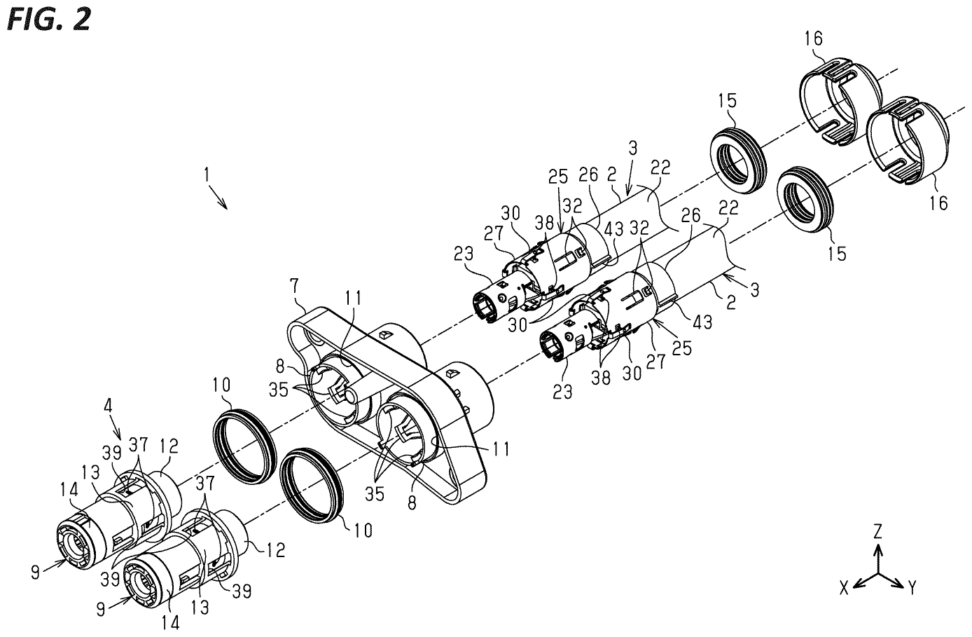

As shown in FIGS. 1 and 2, the connector section 4 particularly includes a flange part 7 to which the one or more terminal assemblies 3 are attached.

As shown in FIG. 2, the flange part 7 particularly includes one or more tubular parts 8 (specifically arranged substantially in parallel) into which the terminal assemblies 3 are inserted.

The flange part 7 specifically is to be secured to the mating connector 5 by one or more, particularly a plurality of fasteners such as bolts (not shown).

The connector section 4 particularly includes a cap 9 to which a distal end of the terminal assembly 3 is attached.

Specifically, a pair of the caps 9 are provided in accordance with the number of terminal assemblies 3.

A connector seal 10 particularly substantially is provided between the flange part 7 and the cap 9, the connector seal 10 sealing a gap between the flange part 7 and the cap 9 when the connector section 4 engages with the mating connector 5.

The connector seal 10 particularly is to be at least partly arranged between a groove 11 formed in the tubular part 8 of the flange part 7, and a distal end of an outer peripheral cylindrical portion 13 that at least partly covers an inner peripheral portion 12 of the cap 9.

An annular metal body 14 particularly is attached at or near a distal end of the cap 9, the metal body 14 making it possible to detect via electrical conduction whether the connector section 4 has fully engaged with the mating connector 5.

As shown in FIG. 2, the connector section 4 particularly includes a wire seal 15 at or near a proximal end of the flange part 7, the wire seal 15 at least partly sealing a gap between the shielded electric wire 2 and the flange part 7.

The wire seal 15 specifically is to be held between the shielded electric wire 2 and the flange part 7 by at least one back retainer 16.

The back retainer 16 particularly is a rear holder that substantially closes the flange part 7 at a rear thereof, and/or one or more, particularly a pair of the back retainers 16 particularly are provided in accordance with the number of terminal assemblies 3.

The back retainer 16 particularly is secured to the flange part 7 by a known locking structure.

### Shielded Electric Wire 2

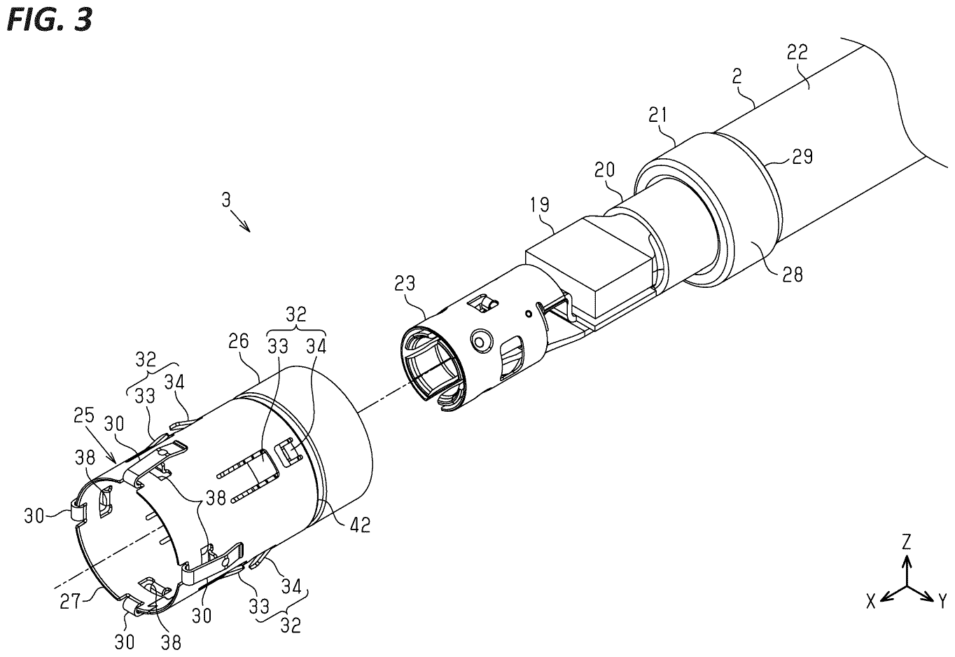

As shown in FIG. 3, the shielded electric wire 2 particularly includes a core wire 19, an insulating coating 20 that at least partly covers the core wire 19 at a periphery thereof, a shielding layer (particularly comprising a braided wire 21) arranged on an outer peripheral surface of the insulating coating 20, and/or a sheath 22 that at least covers the shield layer (particularly the braided wire 21), specifically substantially covers all sides of the shield layer, particularly of the braided wire 21.

The core wire 19 is, for example, a single-core conductor.

An electrical terminal 23 particularly is to be secured to a portion of the core wire 19 that is exposed from the insulating coating 20.

The electrical terminal 23 specifically is an inner conductor terminal that in use connects the mating connector 5 and the core wire 19.

The insulating coating 20 is, for example, made of an insulating material such as a synthetic resin.

The braided wire 21 is formed by, for example, braiding thin metal wires.

The shielding layer may be formed by or comprise, for example, one or more substantially planar conductive layers or foils being directly or indirectly arranged on the insulating coating 20.

The sheath 22 is, for example, a protective coating made of a resin.

### Metal Shell 25

As shown in FIGS. 2 and 3, the shielded connector 1 (terminal assembly 3) particularly includes a tubular metal shell 25 that in use electrically connects the shielding layer (particularly the braided wire 21) of the shielded electric wire 2 to a shield material (not shown) of the mating connector 5 during engagement of the connector section 4 with the mating connector 5.

The metal shell 25 particularly is secured or securable to a distal end of the shielded electric wire 2 so that the electrical terminal 23 of the shielded electric wire 2 particularly is positioned at an outer side of the metal shell 25.

The metal shell 25 of the present example substantially has a cylindrical shape.

The metal shell 25 particularly includes at least one crimping portion 26 that is to be secured to the shielding layer (particularly the braided wire 21) by crimping or bending or deforming, and at least one connection portion 27 that in use contacts the shield material (not shown) of the mating connector 5 when the shield connector 1 is connected to the mating connector 5.

The crimping portion 26 particularly is arranged at or near a proximal end of the metal shell 25.

As shown in FIG. 3, the crimping portion 26 is to be at least partly crimped or bent or deformed onto a folded portion 28 formed at a distal end of the shielding layer (particularly the braided wire 21) specifically with an underlay ring 29 at least partly placed underneath.

The crimping portion 26 specifically is to be firmly secured to the folded portion 28 of the shielding layer (particularly the braided wire 21) by deformation caused by a load applied during crimping or bending or deforming.

Note that the proximal end of the metal shell 25 may include not only the proximal end itself but also a surrounding area thereof.

As shown in FIGS. 2 to 4, the connection portion 27 particularly includes at least one folded spring 30 that is to be electrically connected to the shield material (not shown) of the mating connector 5 during engagement of the connector section 4 with the mating connector 5.

Specifically, a plurality (four in the present example) of the folded springs 30 are provided on the metal shell 25 and/or substantially are arranged at equal intervals in a circumferential direction on an outer peripheral surface of the metal shell 25.

The folded spring 30 particularly is formed to have, for example, a cantilever-like shape that is elastically or resiliently deformable.

### Securing Structure of Terminal Assembly 3

As shown in FIGS. 3 to 5, one or more, particularly a pair of locking pieces 32 are formed on the metal shell 25, the one or more, particularly the pair of locking pieces 32 securing the terminal assembly 3 to the flange part 7 during engagement of the terminal assembly 3 with the flange part 7.

The one or more, particularly the pair of locking pieces 32 include at least one cut-and-raised piece 33 formed to be elastically or resiliently deformable, and/or at least one restriction piece 34 particularly arranged to substantially face the cut-and-raised piece 33 in an axial direction of the metal shell 25 (X-axis direction in FIG. 3).

Specifically, a plurality of the pairs of locking pieces 32 substantially are arranged at equal intervals in the circumferential direction on the outer peripheral surface of the metal shell 25.

As shown in FIG. 5, at least one snap-engagement wall 35 particularly is provided on an inner surface of the flange part 7 so as to protrude, the snap-engagement wall 35 substantially snap-engaging into place between the cut-and-raised piece 33 and the restriction piece 34.

A plurality of the snap-engagement walls 35 specifically are formed so as to form a set with or correspond to the pair of locking pieces 32.

The terminal assembly 3 particularly is allowed to engage with the flange part 7 due to the cut-and-raised piece 33 bending in a process of inserting the terminal assembly 3 into the flange part 7 during engagement of the terminal assembly 3 with the flange part 7.

Specifically, when the snap-engagement wall 35 of the flange part 7 substantially is positioned between the cut-and-raised piece 33 and the restriction piece 34 in this insertion process, the terminal assembly 3 and the flange part 7 particularly are secured together due to the snap-engagement wall 35 snap-engaging into place between the cut-and-raised piece 33 and the restriction piece 34.

### Securing Structure of Cap 9

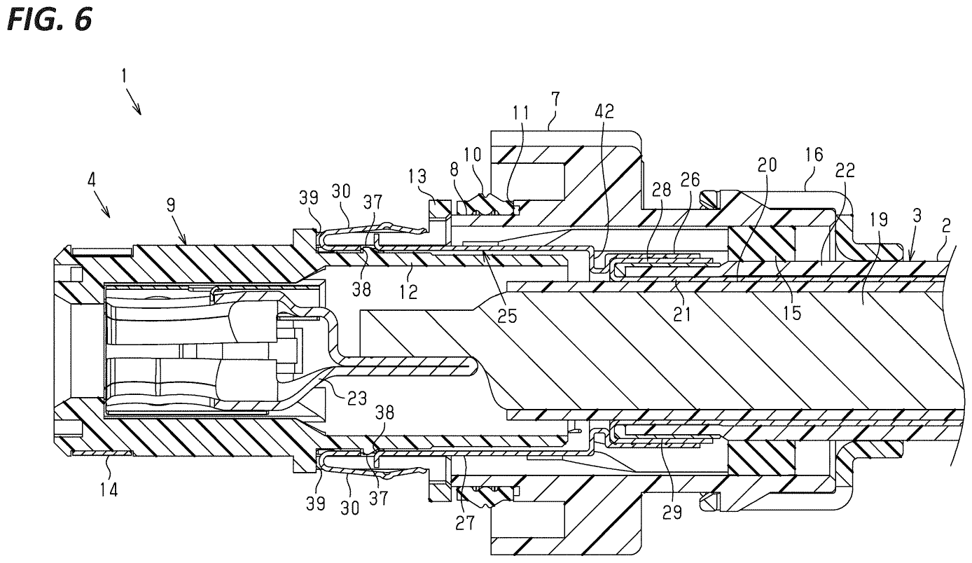

As shown in FIGS. 2 and 6, at least one projection 37 for securing the cap 9 to the metal shell 25 particularly is formed on the inner peripheral portion 12 of the cap 9.

Specifically, a plurality of projections 37 substantially are arranged at equal intervals in the circumferential direction on or at a front surface of the inner peripheral portion 12.

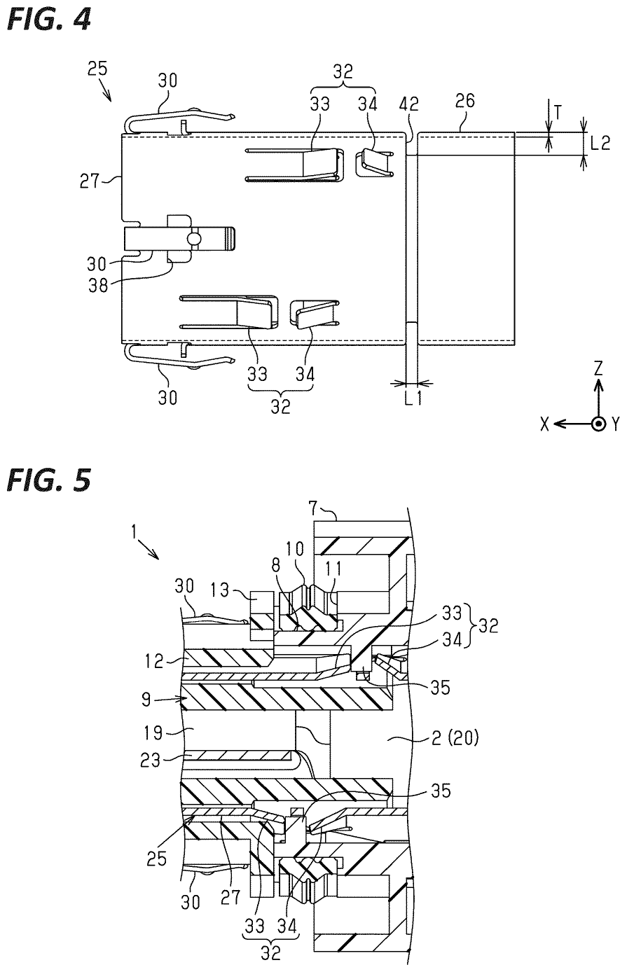

As shown in FIGS. 4 and 6, one or more, particularly a plurality of holes 38 for allowing the one or more projections 37 to snap-engage therewith particularly are formed in the metal shell 25.

The hole 38 particularly is provided to form a set with the projection 37 and/or particularly is arranged on or at a rear surface of the folded spring 30.

The cap 9 particularly is to be attached to the terminal assembly 3 by at least partly inserting the metal shell 25 into a gap between the inner peripheral portion 12 and the outer peripheral cylindrical portion 13.

Specifically, at this time, the cap 9 is to be secured to the terminal assembly 3 due to the one or more projections 37 of the inner peripheral portion 12 of the cap 9 engaging with the one or more holes 38 of the metal shell 25.

During engagement of the cap 9, the folded spring 30 of the metal shell 25 particularly at least partly is exposed at an outer side from at least one slit 39 formed in the outer peripheral cylindrical portion 13 of the cap 9.

### Deformation Suppression During Crimping of Metal Shell 25

As shown in FIGS. 3 and 4, at least one recess 42 for substantially suppressing or reducing deformation during crimping is formed in the metal shell 25 before crimping over an area (particularly substantially an entire area in the circumferential direction) between the crimping portion 26 and the connection portion 27.

As shown in FIG. 4, when a dimension in the axial direction of the metal shell 25 (X-axis direction in FIG. 4) at the recess 42 is defined as a groove width L1, the groove width L1 of the recess 42 particularly is set to a value within a range from a value being approximately a thickness T of the metal shell 25 to about three times the thickness T of the metal shell 25.

Specifically, when the plate thickness T of the metal shell 25 particularly is about 0.5 mm for example, the groove width L1 of the recess 42 is set to a value of “about 0.5 (may also be approximately 0.4) to about 1.5 mm”. The groove width L1 is preferably set to a value of “about 0.4 to about 1 mm”.

When a dimension in a radial direction of the metal shell 25 (Z-axis direction in FIG. 4) is defined as a groove depth L2, the groove depth L2 of the recess 42 particularly substantially is set to a value greater than the thickness T of the metal shell 25 and/or smaller than about five times the thickness T of the metal shell 25.

Specifically, when the plate thickness T of the metal shell 25 is 0.5 mm for example, the groove depth L2 of the recess 42 is set to a value of “about 0.5 to about 2.5 mm”. The groove depth L2 is preferably set to a value of “about 0.85 to about 2 mm”.

The recess 42 particularly is arranged at a position, in the axial direction of the metal shell 25, closer to the proximal end of the metal shell 25 than a center in this axial direction.

### Shape of Metal Shell 25 After Crimping

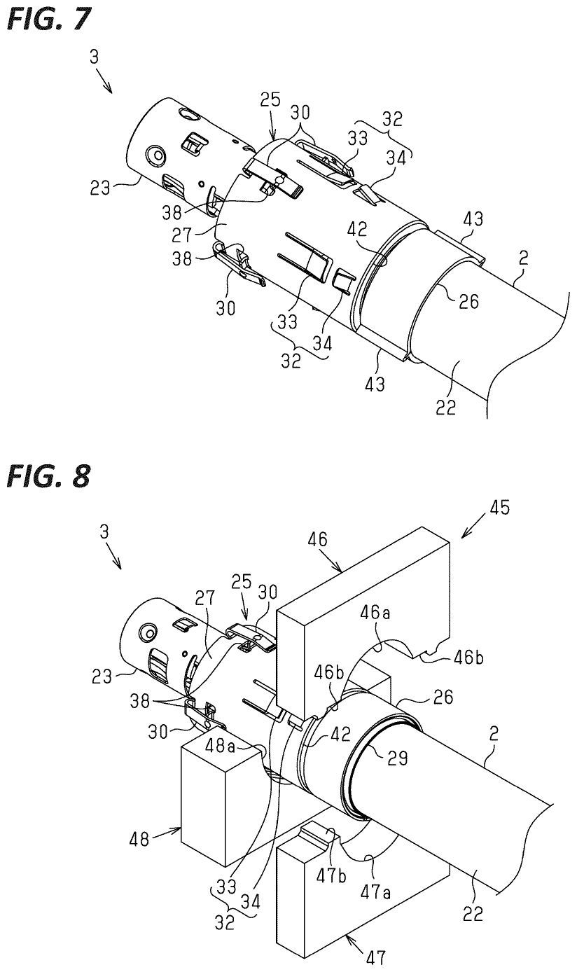

As shown in FIG. 7, the metal shell 25 particularly includes a close-fitting bent portion 43 formed by bending, folding and/or embossing a base material of the metal shell 25 substantially outward when forming the crimping portion 26 at the metal shell 25.

The close-fitting bent portion 43 is or comprises, for example, a deformed portion that inevitably occurs in the crimping portion 26 when the crimping portion 26 is formed at the metal shell 25 using a die.

Specifically, a pair of the close-fitting bent portions 43 of the present example are formed so as to substantially face each other on the lateral sides (e.g. the left and right). Specifically, the pair of close-fitting bent portions 43 are provided at a position on one lateral side e.g. in a left-right direction (“3 o'clock” position) and a position on the other lateral side e.g. in the left-right direction (“9o'clock” position) when viewing the metal shell 25 from the axial direction.

### [Operation of Embodiment]

Next, an operation of the shielded connector 1 and a terminal crimping method of the present embodiment will be described.

### Crimping Die 45

As shown in FIG. 8, the crimping portion 26 of the metal shell 25 particularly is crimped or bent or deformed onto the shielding layer (particularly the braided wire 21) by using a crimping die 45 shown in the drawing.

Specifically, the crimping die 45 includes a first blade die 46 and a second blade die 47 that sandwich the crimping portion 26 from both sides and at least partly deform the crimping portion 26 by shape deformation.

The first blade die 46 particularly includes a processing surface 46a that applies a deformation load to one side of the outer peripheral surface at the proximal end of the metal shell 25.

The first blade die 46 particularly linearly moves to approach and separate from the metal shell 25 with an initial position thereof being above the metal shell 25.

The second blade die 47 particularly includes a processing surface 47a that at least partly applies a deformation load to the other side of the outer peripheral surface at the proximal end of the metal shell 25.

A position of the second blade die 47 particularly is fixed.

A concave first base material relief portion 46b particularly is formed at one or both ends of the processing surface 46a of the first blade die 46, the first base material relief portion 46b relieving shape deformation of the crimping portion 26 during crimping of the metal shell 25.

A protruding second base material relief portion 47b particularly is formed at one or both ends of the processing surface 47a of the second blade die 47, the second base material relief portion 47b relieving shape deformation of the crimping portion 26 in cooperation with the first base material relief portion 46b during crimping or bending or deforming of the metal shell 25.

Further specifically, the crimping die 45 includes at least one holding die 48 that holds the outer peripheral surface of the connection portion 27 of the metal shell 25 in place during formation of the crimping portion 26.

The holding die 48 particularly includes at least one support surface 48a that supports the connection portion 27 of the metal shell 25 during crimping.

The support surface 48a of the present example is formed to be substantially arc-shaped or bent along half of an outer periphery of the connection portion 27 of the metal shell 25.

The holding die 48 particularly substantially suppresses radially outward deformation of the connection portion 27 of the metal shell 25 by supporting a lower part (particularly substantially a lower half) of a circumferential surface of the connection portion 27 from all sides during crimping of the metal shell 25.

### Manufacturing Method of Crimping Portion 26

As shown in FIG. 8, the terminal assembly 3 to which the metal shell 25 particularly is attached or positioned before crimping is set in the crimping die 45.

Note that the metal shell 25 before crimping particularly has a shape in which the proximal end out of which the crimping portion 26 is to be formed is substantially cylindrical with substantially the same diameter as the connection portion 27.

The connection portion 27 of the metal shell 25 particularly is placed on the support surface 48a of the holding die 48, and/or the proximal end of the metal shell 25 is arranged between the first blade die 46 and the second blade die 47.

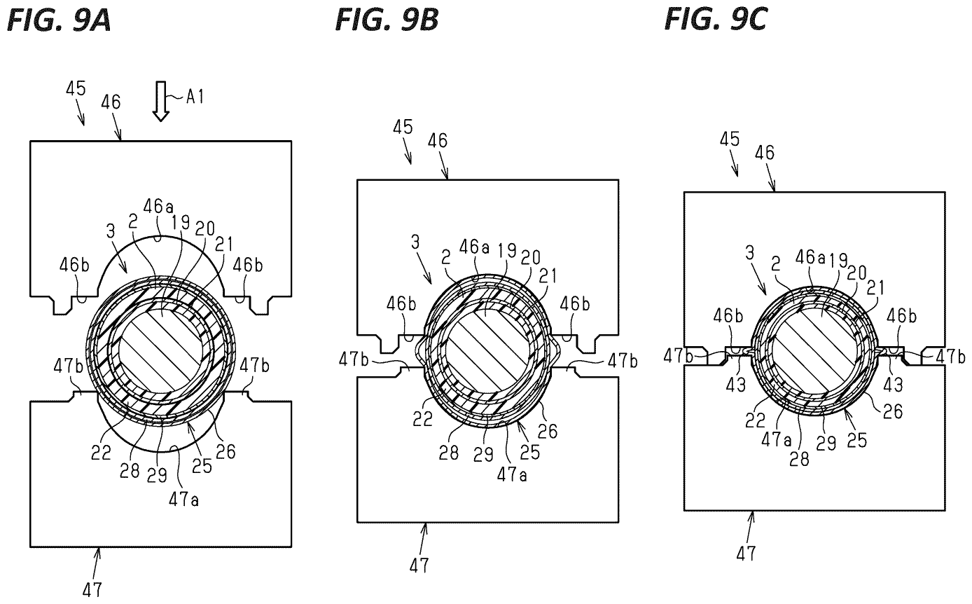

As shown in FIG. 9A, after the terminal assembly 3 is set or arranged in or at the crimping die 45, the first blade die 46 starts moving so as to approach the second blade die 47.

In the case of the present example, when the terminal assembly 3 is set or arranged, the first blade die 46 and the second blade die 47 are brought closer to each other, particularly the first blade die 46 starts moving linearly towards the second blade die 47 e.g. downward (direction of arrow A1 in FIG. 9A) relative to the second blade die 47 whose position is fixed.

Specifically, as shown in FIG. 9B, particularly upon the first blade die 46 reaching the proximal end of the metal shell 25, the proximal end of the metal shell 25 substantially is crushed from all sides by the first blade die 46 and the second blade die 47 by further continuing the movement. That is, the proximal end of the metal shell 25 starts being crimped or bent or deformed onto the shielded electric wire 2 by being clamped by the first blade die 46 and the second blade die 47.

When the crimping load is applied to the proximal end of the metal shell 25 by the first blade die 46 and the second blade die 47, substantially both ends of the proximal end of the metal shell 25 in a left-right direction in the drawing particularly are deformed to curve outward by being sandwiched between a pair of the first base material relief portions 46b of the first blade die 46 and a pair of the second base material relief portions 47b of the second blade die 47.

With this, the close-fitting bent portion 43 particularly starts being formed substantially at both ends in the left-right direction in the drawing at the proximal end of the metal shell 25. With this, the proximal end of the metal shell 25 particularly is clamped and crimped onto the shielding layer (particularly the braided wire 21) via the underlay ring 29.

As shown in FIG. 9C, when the first blade die 46 moves to its end position, one or more, particularly a pair of the close-fitting bent portions 43 particularly is formed due to the first base material relief portion 46b of the first blade die 46 and the second base material relief portion 47b of the second blade die 47 heavily crushing particularly one or both left and right ends of the metal shell 25.

That is, the first base material relief portion 46b and the second base material relief portion 47b particularly form the close-fitting bent portion 43 at the metal shell 25 by sandwiching and curving part of the proximal end of the metal shell 25.

As described above, the proximal end of the metal shell 25 is crimped or bent or deformed, particularly via the underlay ring 29, onto an outer peripheral surface of the shielding layer (particularly the braided wire 21) of the shielded electric wire 2, specifically, the folded portion 28 of the shielding layer (particularly the braided wire 21), by being clamped by the first blade die 46 and the second blade die 47.

In this way, the crimping portion 26 for securing the metal shell 25 to the shielded electric wire 2 particularly is formed at the proximal end of the metal shell 25.

### Analysis of Crimping Deformation

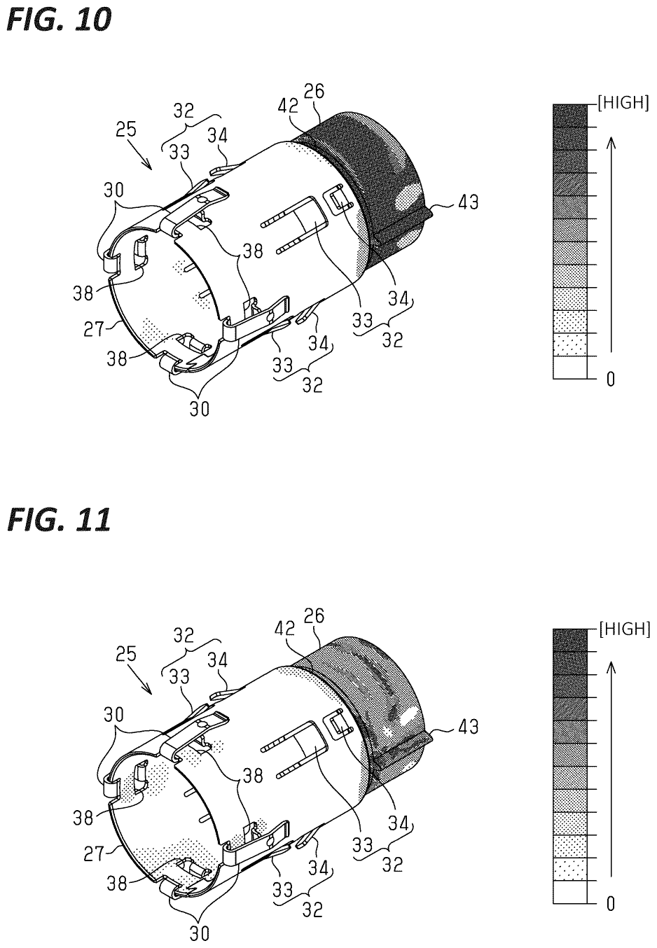

FIGS. 10 and 11 show analysis results of a stress distribution of the deformation load produced on the metal shell 25 due to crimping.

FIG. 10 shows the analysis result when the proximal end of the metal shell 25, the connection portion 27 thereof being supported by the holding die 48, particularly is sandwiched between the first blade die 46 and the second blade die 47 and the crimping portion 26 is formed.

FIG. 11 shows the analysis result after the first blade die 46, the second blade die 47, and the holding die 48 are removed from the metal shell 25 after the crimping portion 26 has been formed.

In these drawings, a magnitude of the stress is indicated by the density of the dots, and the denser the dots are, the greater the deformation load is.

As shown in FIG. 10, high stress particularly is applied to the crimping portion 26 when the crimping portion 26 is clamped between the first blade die 46 and the second blade die 47.

However, in the case of the present example, the crimping load applied to the crimping portion 26 is less likely transmitted to the connection portion 27, because the at least one recess 42 particularly is formed substantially between the crimping portion 26 and the connection portion 27.

Therefore, the deformation load applied to the connection portion 27 is reduced.

Thus, it is possible to make the connection portion 27 of the metal shell 25 less likely to undergo deformation.

As shown in FIG. 11, when the first blade die 46 and the second blade die 47 are removed from the crimping portion 26, it can be seen that the deformation load produced on the crimping portion 26 particularly is less than during crimping by the first blade die 46 and the second blade die 47.

Locations showing an increase in the deformation load occur at the connection portion 27 because the holding die 48 is removed from the connection portion 27, but this increase is localized and the increase amount is small.

Therefore, it can be seen that even after the first blade die 46, the second blade die 47, and the holding die 48 are removed from the metal shell 25, the deformation load applied to the connection portion 27 particularly remains small.

Thus, it can be seen that the deformation of the connection portion 27 of the metal shell 25 even after crimping is suppressed.

### [Effects of Embodiment]

According to the shielded connector 1 and the terminal crimping method of the present embodiment, the following effects can be obtained.
(1) In the shielded connector 1 including the shielded electric wire 2 and the metal shell 25, the metal shell 25 includes the crimping portion 26 that is to be secured to the shielding layer (particularly the braided wire 21) by crimping or bending or deforming and the connection portion 27 that contacts the shield material of the mating connector 5.

The at least one recess 42 for suppressing deformation during crimping or bending or deforming is formed in the metal shell 25 before crimping particularly over more than about half, further particularly more than about ⅔, further particularly more than about ¾, further particularly the substantially entire area in the circumferential direction between the crimping portion 26 and the connection portion 27.

According to the present configuration, the at least one recess 42 allows the crimping load applied to the crimping portion 26 to be less likely transmitted to the connection portion 27, when the crimping portion 26 of the metal shell 25 is crimped or bent or deformed onto the shielding layer (particularly the braided wire 21) of the shielded electric wire 2.

Therefore, the connection portion 27 of the metal shell 25 particularly is less likely to undergo shape deformation during crimping of the metal shell 25.

That is, shape deformation of the connection portion 27, which is connected to the shield material of the mating connector 5, at the metal shell 25 particularly is suppressed.

Thus, it is possible to stably connect the metal shell 25 to the mating connector 5. Therefore, it is possible to successfully connect the metal shell 25 to an engagement opening of the mating connector 5.
(2) The groove width L1 of the at least one recess 42 particularly is set to the value within the range from the value being approximately the thickness T of the metal shell 25 to about three times the thickness T of the metal shell 25.

According to this configuration, the dimension of the groove width L1 of the recess 42 being optimal further contributes to deformation suppression of the connection portion 27 of the metal shell 25 during crimping.
(3) The at least one recess 42 particularly is arranged at the position, in the axial direction of the metal shell 25, closer to the proximal end of the metal shell 25 than the center in this axial direction. In the case of a structure in which the proximal end of the metal shell 25 is crimped or bent or deformed onto the shielding layer (particularly the braided wire 21), the connection portion 27 may deform into a flared shape upon the crimping load produced on the crimping portion 26 being transmitted to the connection portion 27 at a side opposite the proximal end.

However, in the case of the present configuration, the deformation load on the crimping portion 26 is less likely to be transmitted to the connection portion 27 and the metal shell 25 is less likely to deform into a flared shape even when using a structure in which the proximal end of the metal shell 25 is crimped, because the at least one recess 42 for deformation suppression during crimping particularly is provided in the metal shell 25.
(4) The crimping portion 26 after crimping particularly includes the at least one close-fitting bent portion 43 formed by bending the base material of the metal shell 25 outward when forming the crimping portion 26 at the metal shell 25.

According to this configuration, it is possible to form a portion at the metal shell 25 in which the base material is deformed as the close-fitting bent portion 43 as intended, when securing the metal shell 25 to the shielding layer (particularly the braided wire 21) by crimping.

### OTHER EMBODIMENTS

Note that the present embodiment can be modified and implemented as follows. The present embodiment and the following modified examples can be implemented in combination without technically contradicting each other.
A shape of the at least one recess 42 is not limited to a substantially U-shape in a cross-sectional view and may be changed to another shape such as a substantially V-shape or substantially polygonal shape.
The position of the at least one recess 42 in the axial direction of the metal shell 25 may be closer to the proximal end than the center in the axial direction.
At least one serration particularly may be formed on an inner peripheral surface of the crimping portion 26.
The number of the close-fitting bent portions 43 is not limited to two, and may be one or may be three or more.
The metal shell 25 may have a shape in which the close-fitting bent portion 43 is omitted.
The metal shell 25 may have a shape in which the recess 42 is not included after crimping.
The folded portion 28 may be omitted in the shielded electric wire 2, and the metal shell 25 at least partly may be crimped or bent or folded onto a non-folded portion of the shielding layer (particularly the braided wire 21) that is exposed from the sheath 22 in the shielded electric wire 2.
The underlay ring 29 may be omitted from the shielded electric wire 2.
A noise shielding member that covers the insulating coating 20 is not limited to the shielding layer (particularly the braided wire 21), and another member may be used such as a pipe member (pipe shield). As mentioned before, the shielding layer may be formed by or comprise, for example, one or more substantially planar conductive layers or foils being directly or indirectly arranged on the insulating coating 20.
The electrical terminal 23 may be entirely positioned inside the metal shell 25.
The folded spring 30 is not limited to a cantilever-like spring and may be changed to another types of spring, such as a double-supported spring or an embossed spring.
Only one folded spring 30 may be provided.
The shielded connector 1 is not limited to including two terminal assemblies 3, and may include only one terminal assembly 3 or may include three or more terminal assemblies 3.
The shielded connector 1 is not limited to in-vehicle usage and may be used in another apparatus or equipment such as computer systems, network systems or the like.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shielded connector for a shielded electric wire that is to be electrically connected to a mating connector, the shielded connector comprising:
an electrical terminal to be connected to the mating connector; and
a tubular metal shell that is to be connected to a shield material of the mating connector when the electrical terminal is electrically connected to the mating connector, wherein
the metal shell includes at least one crimping portion that is secured to the shielded electric wire by crimping, and a connection portion that contacts the shield material of the mating connector, and
at least one recess for suppressing deformation during crimping is formed in the metal shell before crimping in a circumferential direction between the crimping portion and the connection portion.

2. The shielded connector according to claim 1, wherein the at least one recess for suppressing deformation during crimping is formed in the metal shell before crimping over a substantially entire area in a circumferential direction between the crimping portion and the connection portion.

3. The shielded connector according to claim 1, wherein when a dimension in an axial direction of the metal shell at the recess is defined as a groove width, the groove width of the recess is set to a value within a range from a value being approximately a thickness of the metal shell to about three times the thickness of the metal shell.

4. The shielded connector according to claim 1, wherein when a dimension in a radial direction of the metal shell is defined as a groove depth, the groove depth of the recess substantially is set to a value greater than a thickness of the metal shell and/or smaller than about five times the thickness of the metal shell.

5. The shielded connector according to claim 1, wherein the recess is arranged at a position, in an axial direction of the metal shell, closer to a proximal end of the metal shell than a center in the axial direction.

6. The shielded connector according to claim 1, wherein the crimping portion after crimping includes at least one close-fitting bent portion formed by bending a base material of the metal shell outward when forming the crimping portion at the metal shell.

7. A shielded connector assembly comprising the shielded connector according to claim 1 crimped to a shielded electric wire.

8. A terminal crimping method for manufacturing a shielded connector assembly including a shielded electric wire that is to be electrically connected to a mating connector via an electrical terminal and a substantially tubular metal shell that is connected to a shield material of the mating connector when the electrical terminal is electrically connected to the mating connector, the terminal crimping method comprising:
providing the metal shell including a crimping portion that is to be secured to the shielded electric wire by crimping and a connection portion that is to contact the shield material of the mating connector,
forming in the metal shell before crimping at least one recess for suppressing deformation during crimping in a circumferential direction between the crimping portion and the connection portion, and
securing the metal shell to the shielded electric wire by clamping a proximal end located farther than the recess in the metal shell using a crimping die and crimping the proximal end onto the shielded electric wire.

9. The terminal crimping method according to claim 8, wherein the at least one recess for suppressing deformation during crimping is formed over a substantially entire area in a circumferential direction.

10. The terminal crimping method according to claim 8, wherein
when a dimension in an axial direction of the metal shell at the recess is defined as a groove width, in the forming step the groove width of the recess is set to a value within a range from a value being approximately a thickness of the metal shell to about three times the thickness of the metal shell; and/or
when a dimension in a radial direction of the metal shell is defined as a groove depth, in the forming step the groove depth of the recess substantially is set to a value greater than a thickness of the metal shell and/or smaller than about five times the thickness of the metal shell.
